(19) United States
(12) Patent Application Publication
(10) Pub. No.: US 2008/0105500 A1
(43) Pub. Date: May 8, 2008

(54) Disc brake, in particular for a commercial vehicle

(75) Inventor: Johann Iraschko, Schweitenkirchen (DE)

Correspondence Address: CROWELL & MORING LLP;INTELLECTUAL PROPERTY GROUP, P.O. BOX 14300, WASHINGTON, DC, 20044-4300, US

(73) Assignee: Knorr-Bremse Systeme Fuer Nutzfahrzeuge GmbH, Muenchen (DE)

(21) Appl. No.: 11/790,675

(22) Filed: Apr. 26, 2007

Related U.S. Application Data
(63) Continuation of application No. PCT/EP05/09924, filed on Sep. 15, 2005.

(30) Foreign Application Priority Data
Oct. 26, 2004 (DE) 10 2004 052 148.4
Apr. 6, 2005 (DE) 10 2005 015 774.2

(51) Int. Cl. F16D 55/224

(52) U.S. Cl. 188/72.1

(57) ABSTRACT

A disc brake, in particular for a commercial vehicle, includes a brake caliper that straddles the brake disc, and a clamping device, which is located in the brake caliper and which presses brake linings against both sides of the brake disc during a braking procedure. The brake caliper is held on a fixed brake support so that it can be axially displaced on the application and reaction side. The disc brake is configured in such a way that the brake support includes guide tracks that extend in the displacement direction for guiding the brake caliper on the reaction side. Guide surfaces of the brake caliper or parts that are attached to the latter rest against the tracks.

### CROSS-REFERENCE TO RELATED APPLICATIONS

This application is a continuation of PCT International Application No. PCT/EP2005/009924, filed on Sep. 15, 2005, which claims priority under 35 U.S.C. §119 to German Application No. 10 2004 052 148.4, filed Oct. 26, 2004, and to German Application No. 10 2005 015 774.2, filed Apr. 6, 2005, the entire disclosures of which are expressly incorporated by reference herein.

### BACKGROUND AND SUMMARY OF THE INVENTION

The present invention relates to a disc brake, in particular for a commercial vehicle, having a brake caliper which straddles a brake disc, and a brake application device which is arranged in the brake caliper and by way of which an application-side first brake lining can be pressed against the brake disc during a braking operation. The brake caliper is held on a stationary brake carrier (1) in an axially displaceably guided manner and the reaction-side brake lining likewise is applied by displacement of the brake caliper.

Disc brakes of this type which are actuated, for example pneumatically, are preferably used as sliding caliper brakes, as they require a small amount of space, inter alia, as a result of their construction. Here, the brake caliper is mounted on the brake carrier in an axially displaceable manner.

Here, different requirements are imposed on the caliper mounting. For instance, the brake caliper should be guided on the brake carrier with as little friction as possible and the highest possible precision. Furthermore, the caliper mounting has to be able to absorb, without problems, the mass forces which also occur during high vibration loading, and likewise transverse forces which are produced during braking.

In order to satisfy these requirements, a minimum guide length of the caliper mounting is required, with the result that tilting is precluded during displacement of the brake caliper.

However, the available installation space is very limited, in particular in vehicles having independent suspension. Sliding or floating calipers are known, in which, in order to extend the guide path, the brake caliper is held displaceably on the brake carrier only on the application side or both on the application side and the reaction side by way of guide bearings in the form of guide spars.

These designs are currently not yet optimized with regard to the requirement for installation space. For instance, in the last-mentioned variant, the guide spars protrude on both sides beyond the brake carrier, which leads to a corresponding requirement for installation space.

Moreover, in order to ensure permanent functional reliability of the guide spars, the latter are sealed at the ends with folding bellows made from silicone rubber. However, the function of these folding bellows is endangered by thermal and mechanical loadings, with the result that functional disruptions of the disc brake can occur on account of leakages due to operation.

Furthermore, the structural outlay is considerable, especially with regard to the necessary sealing mechanisms, with the resulting costs. The above-mentioned possible operating disruptions also lead to very significant costs, both with regard to necessary repairs and also with regard to the downtime of the commercial vehicle, which is required for the repair.

The present invention is based on the object of developing a disc brake of the above-described type in such a way that its requirement for installation space is reduced and that the guide mechanisms overall can be manufactured in a simpler and less expensive way and is largely insensitive to mechanical and thermal loadings.

This object is achieved by a disc brake, in particular for a commercial vehicle, having a brake caliper which straddles over a brake disc, and a brake application device which is arranged in the brake caliper and by way of which an application-side first brake lining can be pressed against the brake disc during a braking operation. The brake caliper is held on a stationary brake carrier in an axially displaceably guided manner and the reaction-side brake lining likewise is applied by displacement of the brake caliper. For the reaction-side guidance of the brake caliper, guide tracks, which extend in the displacement direction and against which guide faces of the brake caliper or parts which are connected to the latter bear, are formed directly on the brake carrier. The guide faces are provided on a guide plate, which is fastened to the brake caliper and carries the brake lining, or on the brake lining itself.

In accordance with the present invention, for the reaction-side guidance of the brake caliper, guide tracks, which extend in the displacement direction and against which corresponding guide faces of the brake caliper (or parts which are connected to the latter, in particular, a guide plate) bear, are formed integrally directly on the brake carrier.

As a result of this structural refinement, the brake carrier itself acts as guide bearing, on which the brake caliper or parts which are connected to the latter are mounted directly in an axially displaceable manner. Protruding, separate guide spars can, therefore, be dispensed with.

This results in many advantages, among which first of all is the possibility of minimizing the required installation space.

This is true, first, in comparison with the previous solutions which have bearings on both sides between the caliper and the carrier, but it is also true for embodiments having only reaction-side sliding bearings, as the latter can be designed to be shorter and are replaced by the reaction-side axial short guiding means according to the invention between the caliper and the bearing, which is advantageous in various installation situations.

Moreover, as a result of the omission of previously necessary sealing elements such as the above-mentioned folding bellows, an improvement in the operational reliability is achieved. In addition to the reduction in repair and subsequent costs, the invention is also distinguished, above all, by the fact that it can be realized simply and inexpensively, and makes an extremely robust design possible which is unreservedly suitable for the usually rough operation.

The reduction in the manufacturing costs is remarkable, above all, because disc brakes of this type are parts which are made in large numbers and in which cost reductions in principle have great significance.

According to one advantageous development of the invention, the guide tracks of the brake carrier are formed such that the brake caliper is held in a form-fitting manner in the circumferential direction of the brake disc, that is to say in accordance with the braking moment profile.

Instead of the brake caliper, a guide plate which is fastened to the former can also be provided directly with guide faces, or the reaction-side brake lining which forms a structural unit with the brake caliper.

The use of a guide plate, in which the guide faces are provided in an outer part region, while the guide tracks of the brake carrier are arranged on the inside, has the advantage that it is simpler and easier to design in terms of its shape, which is adapted to the guide tracks of the brake carrier. The guide plates can be connected to the brake caliper, for example, by screwing with bolts or the like.

The guide plate, to which the brake lining is fastened, is mounted in the brake carrier in an open manner. Foreign bodies which are whirled up during the driving operation can, therefore, easily escape from the guide tracks or the guide faces.

As a result of the virtually playfree, but at least low-play mounting of the guide plate in the brake carrier, the brake caliper is relieved from the transverse forces which act on the brake lining, with the result that it is not possible for the brake lining to be twisted out of the caliper. Here, the brake lining is preferably connected to the guide plate in a form-fitting manner, as a result of which the lining transverse forces are introduced into the guide plate and, from there, into the brake carrier.

Since, as a result, the brake caliper has only to transmit brake application forces, smaller dimensions and resulting weight savings are possible, as required.

As a result of the favorable division of the brake caliper bearing forces, the application-sided mounting or guiding mechanisms can be of considerably smaller dimensions than a single-sided caliper mounting. This likewise results in weight savings, but also very much in installation advantages.

If a guide plate is used, the compressive force is distributed from the brake caliper to the brake lining via the guide plates. As the latter has high flexural rigidity, a lining carrier plate of the brake lining, to which a friction lining is attached, can be of very thin configuration.

Rattling noises, caused by “jumping of the brake lining”, can therefore be precluded, at least to a large extent, on account of the guidance of the brake caliper (or the part which is connected to the latter) in the brake carrier and, if a guide plate is used, on account of the form-fitting and playfree connection of the brake lining.

Other objects, advantages and novel features of the present invention will become apparent from the following detailed description of the invention when considered in conjunction with the accompanying drawings.

### BRIEF DESCRIPTION OF THE DRAWINGS

In the following, one exemplary embodiment of the invention will be described using the appended drawings, in which:

FIG. 1 shows a part detail of a disc brake according to the invention, in a front view; and

FIG. 2 shows the part detail in a partially sectioned plan view.

### DETAILED DESCRIPTION OF THE DRAWINGS

The figures show a part detail of a disc brake, in particular for a commercial vehicle, having a brake caliper 2, which straddles a brake disc 8 in the upper circumferential region. The brake disc 8 is fastened to a vehicle wheel (not shown) or a vehicle axle.

A brake application device (likewise not shown) is provided, by way of which the application-side brake lining 4 can be pressed against the brake disc 8 during a braking operation. In the exemplary embodiment, only the reaction-side brake lining 4 is shown.

This brake lining 4 is carried by the brake caliper 2, to which end a guide plate 3 is connected by screws 5 to the brake caliper 2. The brake lining 4 is fastened to the guide plate 3 in a form-fitting manner.

Here, on its side which faces the brake caliper 2, the guide plate 3 has journals 12, which protrude into corresponding recesses of the brake caliper 2. The journals 12 are arranged concentrically with respect to the threaded bores of the guide plate 3, into which the screws 5 are screwed.

For the form-fitting connection of the brake lining 4, form-fitting connections 11 are provided in a lining carrier plate 7 of the brake lining 4 and in the guide plate 3. These form-fitting connections 11 can be formed by the use of elevations and depressions, which correspond with one another and serve to absorb the braking moment during braking operations, in which one friction lining 6, which is connected fixedly to the lining carrier plate 7 of the brake lining 4 is pressed against the brake disc 8.

In a partial region of its contour face, the guide plate 3 is configured to have guide faces 10, which bear against a stationary brake carrier 1 on guide tracks 9, and is therefore mounted in the brake carrier 1 such that it can be displaced axially in the direction of the brake disc 8.

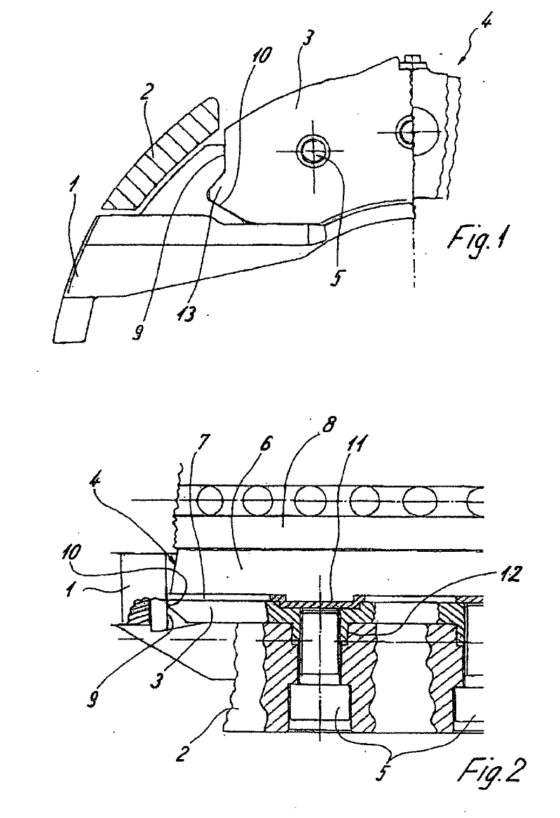

As FIG. 1 shows very clearly in particular, the contour profile of the guide tracks 9 is formed in a defined geometric shape, by which a lug 13, which is formed integrally on the guide plate 3, can engage into the brake carrier 1 such that a form-fitting connection results in the circumferential direction of the brake disc 8, as a result of which braking moments which occur during braking are transmitted reliably to the brake carrier 1. Here, the guide tracks 9 are provided on an inside contour of the brake carrier 1 and the guide faces 10 are provided on an outside contour of the guide plate 3.

Instead of on a separate guide plate 3, the guide faces 10 can also be provided directly on the brake caliper 2 or on the brake lining 4, the latter then being fastened directly to the brake caliper 2.

In all cases, guidance is effected for the axial displacement of the brake caliper 2 within the brake carrier 1.

Table of Reference Symbols

| | |
|---|---|
| 1 | Brake carrier |
| 2 | Brake caliper |
| 3 | Guide plate |
| 4 | Brake lining |
| 5 | Screw |
| 6 | Friction lining |
| 7 | Lining carrier |
| 8 | Brake disc |
| 9 | Guide track |
| 10 | Guide face |
| 11 | Form-fitting connection |
| 12 | Journal |
| 13 | Lug |

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A disc brake having a brake disc, the disc brake comprising:
a caliper which, in use, straddles the brake disc;
a brake application device by which an application-side brake lining is pressed against the brake disc during a braking operation;
a brake carrier on which the caliper is held in an axially displaceable guided manner, a reaction-side brake lining being applied via the axial displacement of the caliper;
guide tracks formed directly on the brake carrier, the guide tracks extending in the axial displacement direction;
guide faces bearing against the guide tracks, the guide faces being operatively configured on either a guide plate fastened to the caliper and carrying the reaction-side brake lining or the reaction-side brake lining itself.

2. The disc brake according to claim 1, wherein the guide tracks are arranged on an inside contour of the brake carrier and the guide faces are arranged on an outside contour of either the guide plate or the reaction-side brake lining, and further wherein the guide tracks and the guide faces correspond to one another in a form-fitting coupling in a circumferential direction of the brake disc.

3. The disc brake according to claim 1, wherein the guide plate is screwed to the caliper.

4. The disc brake according to claim 2, wherein the guide plate is screwed to the caliper.

5. The disc brake according to claim 1, wherein the reaction-side brake lining is coupled to the guide plate in a form-fitting manner.

6. The disc brake according to claim 2, wherein the reaction-side brake lining is coupled to the guide plate in a form-fitting manner.

7. The disc brake according to claim 3, wherein the reaction-side brake lining is coupled to the guide plate in a form-fitting manner.

8. The disc brake according to claim 1, wherein the reaction-side brake lining includes a lining carrier plate, the lining carrier plate having a form-fitting coupling with either the guide plate or the caliper, the form-fitting coupling securing the lining carrier plate against displacement in a circumferential direction of the brake disc.

9. The disc brake according to claim 2, wherein the reaction-side brake lining includes a lining carrier plate, the lining carrier plate having a form-fitting coupling with either the guide plate or the caliper, the form-fitting coupling securing the lining carrier plate against displacement in a circumferential direction of the brake disc.

10. The disc brake according to claim 3, wherein the reaction-side brake lining includes a lining carrier plate, the lining carrier plate having a form-fitting coupling with either the guide plate or the caliper, the form-fitting coupling securing the lining carrier plate against displacement in a circumferential direction of the brake disc.

11. The disc brake according to claim 5, wherein the reaction-side brake lining includes a lining carrier plate, the lining carrier plate having a form-fitting coupling with either the guide plate or the caliper, the form-fitting coupling securing the lining carrier plate against displacement in a circumferential direction of the brake disc.

12. The disc brake according to claim 1, wherein the disc brake is a commercial vehicle disc brake.
